(19) United States
(12) Patent Application Publication
(10) Pub. No.: US 2024/0255941 A1
(43) Pub. Date: Aug. 1, 2024

(54) Method and System to Predict Remaining Useful Life of an Equipment

(71) Applicants: Robert Bosch GmbH, Stuttgart (DE); Bosch Global Software Technologies Private Limited, Bangalore (IN)

(72) Inventors: Prasad Gayathri, Bangalore (IN); Varun Balachandra, Bangalore (IN)

(21) Appl. No.: 18/425,238

(22) Filed: Jan. 29, 2024

(30) Foreign Application Priority Data
Jan. 30, 2023 (IN) 202341005921

(51) Int. Cl. G05B 23/02

(52) U.S. Cl. CPC G05B 23/0283; G05B 23/024

(57) ABSTRACT

A system to predict a remaining useful life of an equipment includes a processor configured to receive signals from sensors of the equipment, extract features from sensor data of the sensors, and obtain a health indicator from the extracted features by principal component analysis. The processor is further configured to determine a critical time beyond which the degradation initiates in the equipment using pautas criteria, predict a future degradation curve, and determine a dynamic failure threshold based on degradation characteristics of the equipment. The dynamic failure threshold is determined in real time based on degradation parameters unique to the equipment.

This application claims priority under 35 U.S.C. § 119 to patent application no. IN 2023 4100 5921, filed on Jan. 30, 2023 in India, the disclosure of which is incorporated herein by reference in its entirety.

The present disclosure relates to estimation of remaining useful life of equipment and more specifically, a method and a system to predict remaining useful life of an equipment.

### BACKGROUND

Modern industries are dependent on highly complex machinery with several interlinked components. A failure in any of these components would result in huge losses in money and time, this in turn decreases the reliability of the machines. Therefore, it is crucial to determine when a fault has occurred in the machine equipment and also the time left to replace it to avoid sudden failure. This time period is known as the Remaining Useful Life (RUL). RUL is a subjective estimate of the number of remaining years/months that an item, component, or system is estimated to be able to function in accordance with its intended purpose before warranting replacement. Determining the RUL allows for better planning of maintenance activities and reduces costs and risks of sudden failure. Several methodologies have been explored to estimate the remaining useful life (RUL) of components, which can be broadly classified into data-driven, model based and hybrid approaches. An integral factor in all methods is the failure threshold, which determines when the component reaches the end of useful life.

Most existing methods use a fixed static failure threshold based on prior knowledge of the failure characteristics of the component. In studies where prior knowledge is unavailable, the threshold is mostly experienced based. In other cases where there is an abundance of run-to-failure data, that is, periodically collected data of similar components, from the day it was installed to the day it is retired, a similarity-based approach can be used. Here the RUL thresholds are determined based on the similarity between the degradation of the current component and other existing run-to-failure datasets.

These methods are not feasible in real-life scenarios where failure characteristics are not available. Additionally, they do not take into account the environment where it operates and the uniqueness of each component and its degradation. In most of the prior art, less importance is given to threshold determination, which in a way is crucial for accurate prediction of RUL. Additionally, there has never been an attempt to determine a dynamic failure threshold that is unique to each component and depends on the characteristics of its degradation. Some prior arts deploy deep learning techniques to predict the RUL.

The document EP4012525A1 discloses systems and methods for predicting failures and remaining useful life (RUL) for equipment, which can involve, for data received from the equipment comprising fault events, conducting feature extraction on the data to generate sequences of event features based on the fault events; applying deep learning modeling to the sequences of event features to generate a model configured to predict the failures and the RUL for the equipment based on event features extracted from data of the equipment; and executing optimization on the model.

### SUMMARY

According to an exemplary embodiment of the disclosure, a method is to predict a remaining useful life of an equipment, and the equipment is provided with at least one sensor. The method includes extracting features from sensor data of the at least one sensor, obtaining a health indicator from the extracted features by principal component analysis, and determining a critical time beyond which degradation initiates in the equipment. The method further includes predicting a future degradation curve, and determining a dynamic failure threshold based on degradation parameters of the equipment.

According to another exemplary embodiment of the disclosure, a processor is for predicting a remaining useful life of an equipment. The equipment is provided with at least one sensor. The processor is configured to receive sensor data from the at least one sensor, extract features from the sensor data, and obtain a health indicator from the extracted features by principal component analysis. The processor is further configured to determine a critical time beyond which a degradation initiates in the equipment using pautas criteria, predict a future degradation curve, and determine a dynamic failure threshold based on degradation characteristics of the equipment.

### BRIEF DESCRIPTION OF THE DRAWINGS

An embodiment of the disclosure is described with reference to the following accompanying drawings:

FIG. 1 depicts a system to predict remaining useful life of an equipment; and

FIG. 2 depicts a flow chart for a method to predict remaining useful life of an equipment.

### DETAILED DESCRIPTION

The degradation characteristics, that is the characteristics which determine the degradation of a machine equipment include—the developed fault, the operating conditions, the environmental conditions, and the application for which it is used. The present disclosure develops a method to calculate a unique failure threshold based on the degradation characteristics of the component. This threshold would be dynamic, as it shall adapt based on the above-mentioned degradation characteristics.

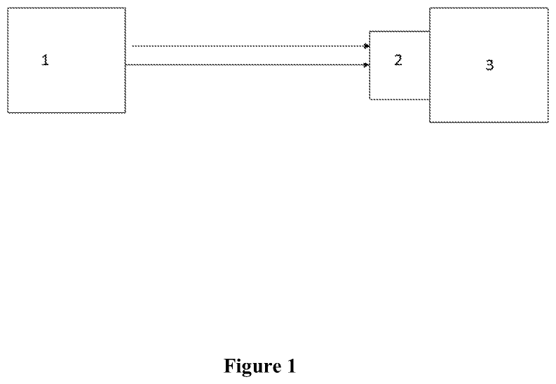

Referring to FIG. 1, the same depicts a system to predict remaining useful life of an equipment. A processor (1) is in communication with a sensor (2) that extracts data from the equipment (3) whose remaining useful life (RUL) is to be estimated. Referring to FIG. 1, disclosed is a processor to predict remaining useful life of an equipment, said equipment provided with at least one sensor. The processor is adapted to receive signals from the sensors (2) of the equipment (3). The processor then extracts features from the sensor (2) data. A health indicator is obtained from the extracted features by principal component analysis and a critical time beyond which the degradation initiates in the equipment (3) is determined using pautas criteria. A future degradation curve is then predicted and the dynamic failure threshold is determined based on degradation parameters of said equipment.

The process to determine the critical time uses a threshold calculated using pautas criteria, which is a formula based on a mean of the health indicator values until a time t and a standard deviation of the health indicator values until the time t.

Predicting the future degradation curve further comprises the steps of fitting an exponential curve into the existing health indicator curve. This is done by estimating the values of values of parameters ϕ, θ, and β. These parameters can be optionally determined by particle swarm optimization such that the error between the health indicator curve and the exponential curve is minimum.

Dynamic failure threshold is determined based on the exponential fit curve, the health indicator, the critical time, and the parameters ϕ and θ of the exponential curve at a time t.

For a better understanding of the disclosure, the specification would exemplify the RUL estimation of ball bearings. It is to be noted that the present exemplification is not limited to ball bearings and should not be construed as limiting the scope of the disclosure. The processor periodically collets sensor data from the bearing to monitor its condition over time. Accelerometers positioned on the bearing housing are used to obtain vibration signals as they contain valuable information about the faults present in a bearing.

To extract useful information from the raw vibration data, the signals are preprocessed, and features are extracted. The features for the exemplified bearings can be the BPFO (Ball Pass Frequency Outer—which is the outer race failing frequency that corresponds physically to the number of balls or rollers that pass through a given point of the outer race each time the shaft makes a complete turn), BPFI (Ball Pass Frequency Inner—or inner race failing frequency that corresponds physically to the number of balls or rollers that pass through a given point of the inner track each time the shaft makes a complete turn), BSF (Ball Spin Frequency—or rolling element failing frequency that corresponds physically to the number of turns that a bearing ball or roller makes each time the shaft makes a complete turn), and FTF (Fundamental Train Frequency—or cage falling frequency that corresponds physically to the number of turns that makes the bearing cage each time the shaft makes a complete turn). The extracted features provide information about faults occurring in different parts of the bearing. These features are combined to make a general indicator for the bearing. Each bearing has its own geometric characteristics from which one can determine its failing frequencies. These frequencies will appear in the spectral signatures when the bearing is deteriorated.

Principal Component Analysis (PCA) is used to create the health indicator from said extracted features. The principal component analysis is a technique to reduce the dimensionality of large dataset in order to increase the interpretability of data whilst minimizing information loss. Principal components are new variables that are constructed as linear combinations or mixtures of the initial variables. These combinations are done in such a way that the new variables (i.e., principal components) are uncorrelated and most of the information within the initial variables is squeezed or compressed into the first components. The first principal component that is obtained from the features is used as the health indicator, as it contains the highest amount of information from all the features.

Once the health indicator is obtained, the critical time must be determined. The critical time denotes the point in time where a healthy bearing develops a fault and the degradation has begun. The estimation of RUL is performed only once the degradation has started, as the developed fault and its degradation curve would determine the end of useful life. The process to determine the critical time uses a threshold calculated using Pauta criteria. Pauta criteria is used to detect outliers (data point differing from other observations in a data) in a data and screens them out. The threshold is given by the following formula:

$$Start threshold ( tc ) = μ + 3 σ \qquad ( 1 )$$

Where μ is the mean of the health indicator values until time tc, and σ is the standard deviation of the health indicator until time tc. Once the threshold is crossed, the degradation has started, and the critical time is obtained. The next step is to predict the future degradation curve to estimate when the curve would cross a failure threshold.

The prediction is done using an exponential degradation model, represented by the following formula:

$$exp HI ( t ) = ϕ + θ * {e}^{β t} \qquad ( 2 )$$

An exponential curve is fit to the existing health indicator curve by estimating the values of parameters ϕ, θ, and β such that the error between the health indicator and the exponential curve is minimum. Particle Swarm Optimization (PSO) can be optionally used to determine these parameters. PSO is an optimization technique which involves moving the particles (points) around in the search-space according to simple mathematical formula over the particle's position and velocity. Each particle's movement is influenced by its local best known position but is also guided toward the best known positions in the search-space, which are updated as better positions are found by other particles. This is expected to move the swarm toward the best solutions.

The final step is to determine the failure threshold. This failure threshold at time t is determined using the formula:

$$Failure threshold ( t ) = exp HI ( t ) + ( tc * slope ( t ) + ϕ ( t ) ) / ( td ( t ) * θ ( t ) + 1 ) - 0.1 * ( H I ( t ) - exp HI ( t ) ) \qquad ( 3 )$$

where expHI=value of fitted health indicator,
HI=value of health indicator,
tc=critical time,
td=time since the degradation started (the difference between current time and critical time)/(time difference between consecutive measurements)),
slope=slope of fitted health indicator at current time, and
ϕ and θ are the parameters of the exponential curve at the current time t.

This formula is estimated by observing the relations between the expected failure threshold and the degradation parameters. The expected failure threshold is assumed as the value of the exponential fit curve at the end of life.

The dynamic threshold is based on the formula proposed in this disclosure. The static threshold is set as the last value of the health indicator. The dynamic threshold can predict the RUL accurately, and a static threshold does not provide good results.

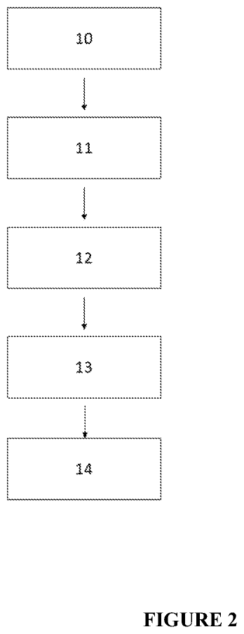

Referring to FIG. 2, the same is a flow chart for a method to predict remaining useful life of an equipment.

Disclosed is a method to predict remaining useful life of an equipment. The equipment is provided with at least one sensor. The method comprising the steps of: extracting features (10) from the sensor data; obtaining a health indicator (11) from the extracted features by principal component analysis; determining a critical time (12) beyond which the degradation initiates in the machine equipment; predicting a future degradation curve (13); characterized in that method a further step of: determining a dynamic failure threshold (14) based on degradation parameters of said equipment.

The process to determine the critical time (12) uses a threshold, calculated using pautas criteria based on a mean of the health indicator values until a time (tc) and a standard deviation of the health indicator values until the time (tc).

Predicting the future degradation curve (13) further comprises the steps of: fitting an exponential curve into the existing health indicator curve by estimating the values of parameters ϕ, θ, and β; wherein, said parameters are determined such that the error between the health indicator curve and the exponential curve is minimum. The dynamic failure threshold is determined (14) based on: the exponential fit curve; the health indicator; the critical time; and the parameters ϕ and θ of the exponential fit curve at a time t.

The degradation curve for said equipment is updated based on the sensor data received over a time.

The dynamic failure threshold (14) is determined in real time based on the degradation parameters unique to said equipment.

The estimation of useful life begins with extracting features from the sensor data (14). These sensors can be (but not limited to) vibration sensors used in turbomachinery. For monitoring rotating machinery, a number of sensors of various types (velocity transducer, acceleration transducer, and displacement transducer) are mounted on the bearings of the rotating machinery to measure the initial vibration signals.

The extracted features provide information about faults occurring in different parts of the equipment. These features are combined to make a general indicator for the equipment. Each equipment has its own geometric characteristics from which one can determine its failing frequencies.

The next step is to obtain a health indicator (11) from the extracted features by principal component analysis. As explained above, the first principal component that is obtained from the features is used as the health indicator, as it contains the highest amount of information from all the features. The health indicator so obtained is used to denote the state of a component over time. This allows for monitoring of the degradation pattern.

This is followed by determining a critical time (12) beyond which the degradation initiates in the equipment. The process to determine the critical time uses a threshold calculated using Pauta criteria. Pauta criteria is used to detect outliers (data point differing from other observations in a data) in a data and screens them out. The threshold is given by the following formula:

$$Start threshold ( tc ) = μ + 3 σ \qquad ( 4 )$$

Where μ is the mean of the health indicator values until time tc, and σ is the standard deviation of the health indicator until time tc.

Once the threshold is crossed, the degradation has started, and the critical time is obtained. The next step is to predict the future degradation curve (13) to estimate when the curve would cross a failure threshold. It is necessary to extend the health indicator values beyond the current time and estimate how the future degradation characteristics are.

The prediction is done using an exponential degradation model, represented by the following formula:

$$exp HI ( t ) = ϕ + θ * {e}^{β t} \qquad ( 5 )$$

An exponential curve is fit to the existing health indicator curve by estimating the values of parameters ϕ, θ and β such that the error between the health indicator and the exponential curve is minimum. Particle Swarm Optimization (PSO) can be optionally used to determine these parameters. PSO is an optimization technique which involves moving the particles(points) around in the search-space according to simple mathematical formula over the particle's position and velocity. Each particle's movement is influenced by its local best-known position but is also guided toward the best known positions in the search-space, which are updated as better positions are found by other particles. This is expected to move the swarm toward the best solutions.

This is followed by determining a dynamic failure threshold (14) based on degradation parameters of said equipment. Failure threshold denotes the value of the health indicator above which the component is highly prone to failures. The time at which the health indicator crosses this threshold is identified as the end of useful life.

The failure threshold is an integral component in this process and is crucial for estimating the RUL accurately. In most works, a static threshold is determined based on data extracted from previous failures. But this method may not be accurate for a component being utilized in a variety of conditions. This leads to a heavy dependence on data for estimating the threshold, and results in a threshold specific to the use case of the component. Additionally, it does not take into account the characteristics of the degradation as it progresses. Each fault is unique, and its degradation would also be unique. Therefore, a common static failure threshold would not accurately predict RUL.

The final step is to determine the failure threshold. This failure threshold at time t is determined using the formula:

$$Failure threshold ( t ) = exp HI ( t ) + ( tc * slope ( t ) + ϕ ( t ) ) / ( td ( t ) * θ ( t ) + 1 ) - 0.1 * ( H I ( t ) - exp HI ( t ) ) \qquad ( 6 )$$

where expHI=value of fitted health indicator,
HI=value of health indicator,
tc=critical time,
td=time since the degradation started (the difference between current time and critical time)/(time difference between consecutive measurements),
slope=slope of fitted health indicator at current time, and
ϕ and θ are the parameters of the exponential curve at the current time t.

The present disclosure advantageously estimates the failure threshold with no prior knowledge of failure characteristics. It is completely based on the degradation of the component and varies over time as the degradation progresses. This method uses the characteristics of the model that is employed to predict the degradation curve and other characteristics of the degradation.

What is claimed is:

1. A method to predict a remaining useful life of an equipment, said equipment provided with at least one sensor, the method comprising:
extracting features from sensor data of the at least one sensor;
obtaining a health indicator from the extracted features by principal component analysis;
determining a critical time beyond which degradation initiates in the equipment;
predicting a future degradation curve; and
determining a dynamic failure threshold based on degradation parameters of the equipment.

2. The method as claimed in claim 1, wherein determining the critical time uses a threshold, calculated using pautas criteria, based on (i) a mean of values of the obtained health indicator until a time, and (ii) a standard deviation of the values of the obtained health indicator until the time.

3. The method as claimed in claim 1, wherein, predicting the future degradation curve comprises:
fitting an exponential curve into an existing health indicator curve by estimating values of parameters;
wherein the values of the parameters are estimated, such that an error between the existing health indicator curve and the exponential curve is a minimum.

4. The method as claimed in claim 3, wherein, the dynamic failure threshold is determined based on (i) the exponential curve, (ii) the health indicator, (iii) the critical time, and (iv) the parameters of the exponential curve at a current time.

5. The method as claimed in claim 1, wherein the future degradation curve for the equipment is updated based on the sensor data received over time.

6. The method as claimed in claim 1, wherein:
the dynamic failure threshold is determined in real time based on the degradation parameters, and
the degradation parameters are unique to the equipment.

7. A processor to predict a remaining useful life of an equipment, said equipment provided with at least one sensor, said processor configured to:
receive sensor data from the at least one sensor;
extract features from the sensor data;
obtain a health indicator from the extracted features by principal component analysis;
determine a critical time beyond which a degradation initiates in the equipment using pautas criteria;
predict a future degradation curve; and
determine a dynamic failure threshold based on degradation characteristics of the equipment.

8. The processor as claimed in claim 7, wherein the processor is configured to determine the critical time using a threshold, calculated using pautas criteria, based on (i) a mean of values of the obtained health indicator until a time, and (ii) a standard deviation of the values of the obtained health indicator until the time.

9. The processor as claimed in claim 7, wherein predicting the future degradation curve comprises:
fitting an exponential curve into an existing health indicator curve by estimating values of parameters;
wherein the values of the parameters are estimated, such that an error between the existing health indicator curve and the exponential curve is a minimum.

10. The processor as claimed in claim 7, wherein the dynamic failure threshold is determined based on (i) the exponential curve, (ii) the health indicator, (iii) the critical time, and (iv) the parameters of the exponential curve at a current time.
